(19) United States
(12) Patent Application Publication
(10) Pub. No.: US 2012/0168282 A1
(43) Pub. Date: Jul. 5, 2012

(54) AUTOMATED PICK AND STOW SYSTEM

(76) Inventors: Charles A. Jones, Murray, KY (US); Earl Ortner, Murray, KY (US)

(21) Appl. No.: 12/985,266

(22) Filed: Jan. 5, 2011

(51) Int. Cl. B65G 17/16

(52) U.S. Cl. 198/793

(57) ABSTRACT

A pick and stow system includes a conveyor system having a plurality of interconnected modules forming a continuous conveyor, each module having a first side and a second side and each configured for forming a shelf on both the first side and the second side. The system also includes a conveyor driver coupled with the conveyor and configured for driving the conveyor, thereby presenting one of the plurality of modules at a loading location for loading or removing an item onto or from the shelf of the module. In some embodiments, a first wheel and a second wheel are each configured for coupling with each of the plurality of modules of the conveyor as the conveyor is driven about the first wheel and the second wheel, such that the conveyor has two substantially vertical sections and a curved section at each of the first and second wheels.

### FIELD

In general, embodiments of the invention relate to automated pick and stow systems. More specifically, embodiments of the invention relate to vertical automated pick and stow systems having interconnected modules forming shelves.

### BACKGROUND

Historically, organizational storage and retrieval systems such as pick and stow systems involve significant user coordination, that is, manual coordination. Some storage systems, for example, include a stationary shelving system labeled using a numbering system whereby items are placed on numbered shelves and the numbers are recorded in a log. Such a system typically requires the user to look up the item of interest in the log, determine the location of the numerical identifier and physically retrieve the item from the proper shelf. Such systems are generally spread over a large space, and in some instances, the shelves are stacked vertically thereby requiring the user to climb a ladder to retrieve the desired item. One example, of these types of pick and stow systems are those used in some libraries, whereby books are catalogued using an alpha-numerical convention and then stowed based on their numerical identifier. The user can then retrieve the book using the alpha-numerical convention. However, stowing and retrieval of items can take significant amounts of time, particularly if multiple items are being stowed/retrieved, thereby resulting in inefficient use of resources. Other limitations of such systems include consequential possibility for error in stowing and/or retrieving. Additionally, such errors can be very difficult and costly to correct, particularly if the error involves an improperly stowed item or items. In such a case, it may be very difficult to retrieve the item due to the improper stowing. Therefore, an automated system for pick and stow of items is needed.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later. Embodiments of the invention address the above needs and/or achieve other advantages by providing pick and stow systems.

According to embodiments of the invention, a pick and stow system includes a conveyor system comprising a plurality of interconnected modules forming a continuous conveyor, each module having a first side and a second side and each configured for forming a shelf on both the first side and the second side and a conveyor driver coupled with the conveyor and configured for driving the conveyor, thereby presenting one of the plurality of modules at a loading location for loading or removing an item onto or from the shelf of the module. In some embodiments, the system also includes a supply conveyor system configured for interacting with the conveyor proximate the loading location and for loading or removing an item onto or from the shelf of the module.

In some embodiments, the conveyor driver comprises a motor coupled with the conveyor and configured for driving the conveyor. In some such embodiments, the motor comprises a stepping motor configured for receiving stepping instructions for driving the conveyor such that each of the plurality of modules can be presented at the loading location based on particular stepping instructions.

In some embodiments, the conveyor system also includes a second plurality of interconnected modules forming a second continuous conveyor, each module having a first side and a second side and each configured for forming a shelf on both the first side and the second side. In some such embodiments, the continuous conveyor and the second continuous conveyor are coupled such that the conveyor driver drives them simultaneously.

According to embodiments of the invention, a pick and stow system includes a conveyor system comprising a plurality of interconnected modules forming a continuous conveyor, each module having a first side and a second side and each configured for forming a shelf on both the first side and the second side, a first wheel at an upper location and configured for coupling with each of the plurality of modules of the conveyor as the conveyor is driven about the first wheel, a second wheel at a lower location and configured for coupling with each of the plurality of modules of the conveyor as the conveyor is driven about the second wheel, such that the conveyor has two substantially vertical sections and a curved section at each of the first and second wheels, the modules comprising the two substantially vertical sections and the curved sections subject to change as the conveyor is driven, and a conveyor driver configured for coupling with and driving at least one of the first or second wheels, thereby driving the conveyor and presenting one of the plurality of modules at a loading location for loading or removing an item onto or from the shelf of the module. In some embodiments, the system also includes a supply conveyor system configured for interacting with the conveyor proximate the loading location and for loading or removing an item onto or from the shelf of the module.

In some embodiments, the conveyor driver comprises a motor coupled with the conveyor and configured for driving the conveyor. In some such embodiments, the motor comprises a stepping motor configured for receiving stepping instructions for driving the conveyor such that each of the plurality of modules can be presented at the loading location based on particular stepping instructions.

In some embodiments, the conveyor system also includes a second plurality of interconnected modules forming a second continuous conveyor, each module having a first side and a second side and each configured for forming a shelf on both the first side and the second side. In some such embodiments, the continuous conveyor and the second continuous conveyor are coupled such that the conveyor driver drives them simultaneously.

According to embodiments of the invention, a pick and stow system includes a conveyor system comprising a plurality of interconnected modules forming a continuous conveyor, each module having a first side and a second side and each configured for forming a shelf on both the first side and the second side, a first wheel at an upper location and configured for coupling with each of the plurality of modules of the conveyor as the conveyor is driven about the first wheel, a second wheel at a lower location and configured for coupling with each of the plurality of modules of the conveyor as the conveyor is driven about the second wheel, such that the conveyor has two substantially vertical sections and a curved section at each of the first and second wheels, the modules comprising the two substantially vertical sections and the curved sections subject to change as the conveyor is driven, and a conveyor driver configured for coupling with and driving at least one of the first or second wheels, thereby driving the conveyor and presenting one of the plurality of modules at a loading location for loading or removing an item onto or from the shelf of the module, and a supply conveyor system configured for interacting with the conveyor proximate the loading location and for loading or removing an item onto or from the shelf of the module. In some embodiments, the supply conveyor system comprises a loading system configured for loading the item onto the shelf of the module.

In some embodiments, the conveyor driver comprises a motor coupled with the conveyor and configured for driving the conveyor. In some such embodiments, the motor comprises a stepping motor configured for receiving stepping instructions for driving the conveyor such that each of the plurality of modules can be presented at the loading location based on particular stepping instructions.

In some embodiments, the conveyor system also includes a second plurality of interconnected modules forming a second continuous conveyor, each module having a first side and a second side and each configured for forming a shelf on both the first side and the second side. In some such embodiments, the continuous conveyor and the second continuous conveyor are coupled such that the conveyor driver drives them simultaneously. In some of these embodiments, the supply conveyor system is configured for interacting with the conveyor and the second conveyor proximate the loading location and for loading or removing items onto or from the shelf of a module of both the conveyor and the second conveyor.

In some embodiments, two of the plurality of modules are interconnected by both coupling with a rod, the rod being configured for coupling with at least one of the first wheel or the second wheel such that the first or second wheel, when driven, also drives the rod and thereby the modules.

According to embodiments of the invention, a method for stowing an item at a pick and stow system comprising a conveyor system and a supply conveyor system includes providing a conveyor system comprising:

a plurality of interconnected modules forming a continuous conveyor, each module having a first side and a second side and each configured for forming a shelf on both the first side and the second side depending on the orientation of the module; and

a conveyor driver coupled with the conveyor and configured for driving the conveyor, thereby presenting one of the plurality of modules at a loading location for loading or removing an item onto or from the shelf of the module. Then, receiving an item intended for stowing with the pick and stow system, determining a stowing location corresponding with a module at which the item should be stowed, driving the conveyor system such that the determined stowing location is presented proximal the supply conveyor system, and forcing the item from the supply conveyor system into the module corresponding with the determined stowing location. In some embodiments, forcing the item from the supply conveyor system into the module corresponding with the determined stowing location comprises pushing the item from the supply conveyor system into the module. In other embodiments, forcing the item from the supply conveyor system into the module corresponding with the determined stowing location comprises pulling the item from the supply conveyor system into the module.

According to embodiments of the invention, a method for removing an item from a pick and stow system comprising a conveyor system and a supply conveyor system includes providing a conveyor system comprising:

a plurality of interconnected modules forming a continuous conveyor, each module having a first side and a second side and each configured for forming a shelf on both the first side and the second side depending on the orientation of the module; and

a conveyor driver coupled with the conveyor and configured for driving the conveyor, thereby presenting one of the plurality of modules at a loading location for loading or removing an item onto or from the shelf of the module. Then, receiving a request for removing an item from the pick and stow system, determining the stowed location of the requested item, driving the conveyor system based on the determined stowed location of the item such that the module corresponding with the stowed location is presented proximal the supply conveyor system, and forcing the item from the module onto the supply conveyor system. In some embodiments, forcing the item from the module onto the supply conveyor system comprises pushing the item from the module onto the supply conveyor system. In other embodiments, forcing the item from the module onto the supply conveyor system comprises pulling the item from the module onto the supply conveyor system.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a perspective overhead view of a pick and stow system according to embodiments of the invention;

FIG. 2 is a side view of a pick and stow system according to embodiments of the invention;

FIGS. 3A, 3B, and 3C are perspective overhead views of a supply conveyor system of a pick and stow system according to embodiments of the invention;

FIGS. 4A and 4B are perspective overhead views of a conveyor driver coupled with a conveyor of a pick and stow system according to embodiments of the invention;

FIGS. 5A, 5B, 5C, 5D, 5E, 5F, and 5G are various views of modules of a conveyor of a pick and stow system according to embodiments of the invention;

FIG. 6 is a block diagram of a pick and stow system environment according to embodiments of the invention;

FIG. 7 is a flowchart illustrating a method for stowing an item on a pick and stow system; and

FIG. 8 is a flowchart illustrating a method for removing an item from a pick and stow system.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

According to embodiments of the invention, a pick and stow system includes a conveyor system having a plurality of interconnected modules forming a continuous conveyor, each module having a first side and a second side and each configured for forming a shelf on both the first side and the second side. The system also includes a conveyor driver coupled with the conveyor and configured for driving the conveyor, thereby presenting one of the plurality of modules at a loading location for loading or removing an item onto or from the shelf of the module. In some embodiments, a first wheel and a second wheel are each configured for coupling with each of the plurality of modules of the conveyor as the conveyor is driven about the first wheel and the second wheel, such that the conveyor has two substantially vertical sections and a curved section at each of the first and second wheels. In some embodiments, multiple conveyors are driven simultaneously and interact with the supply conveyor system simultaneously.

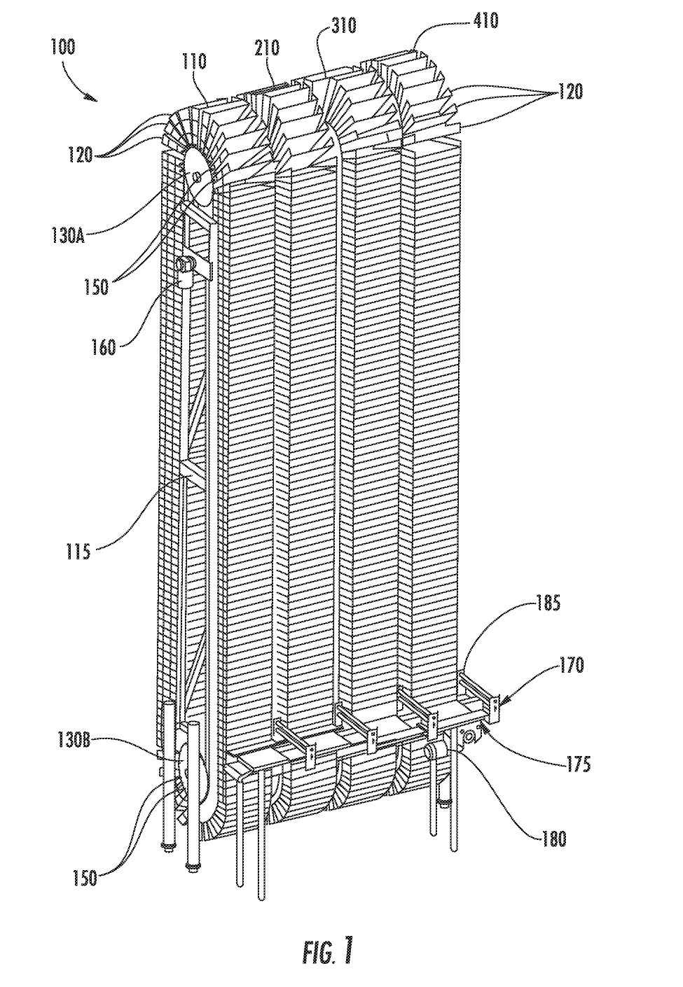

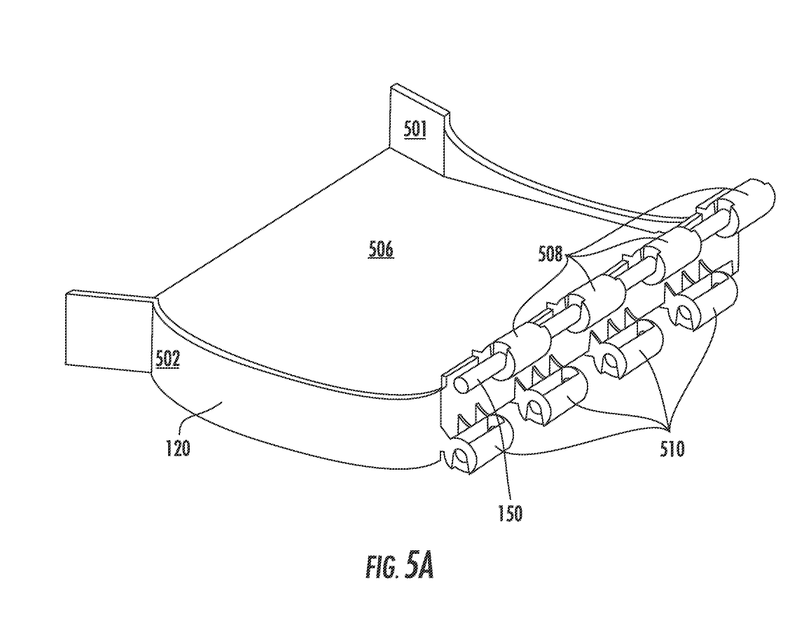

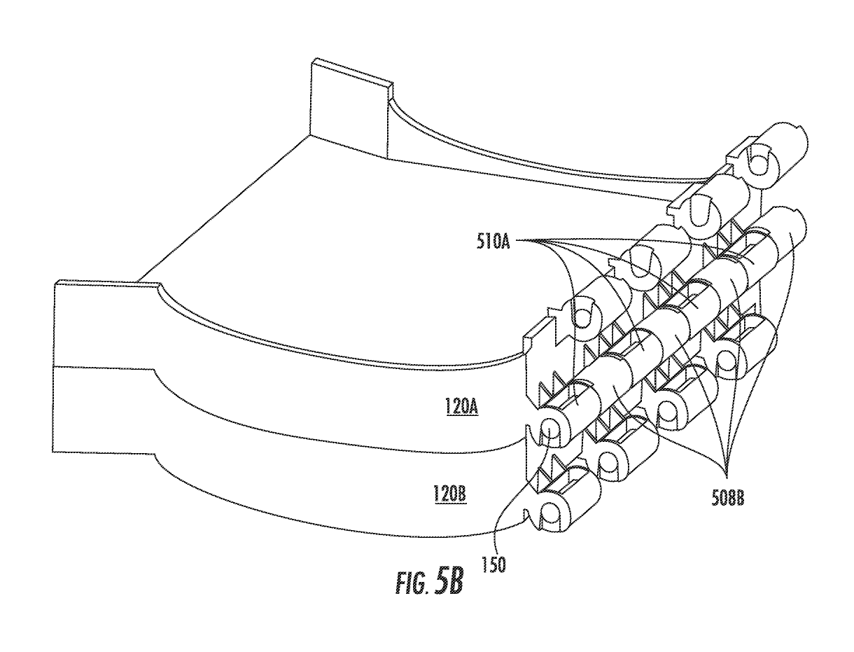

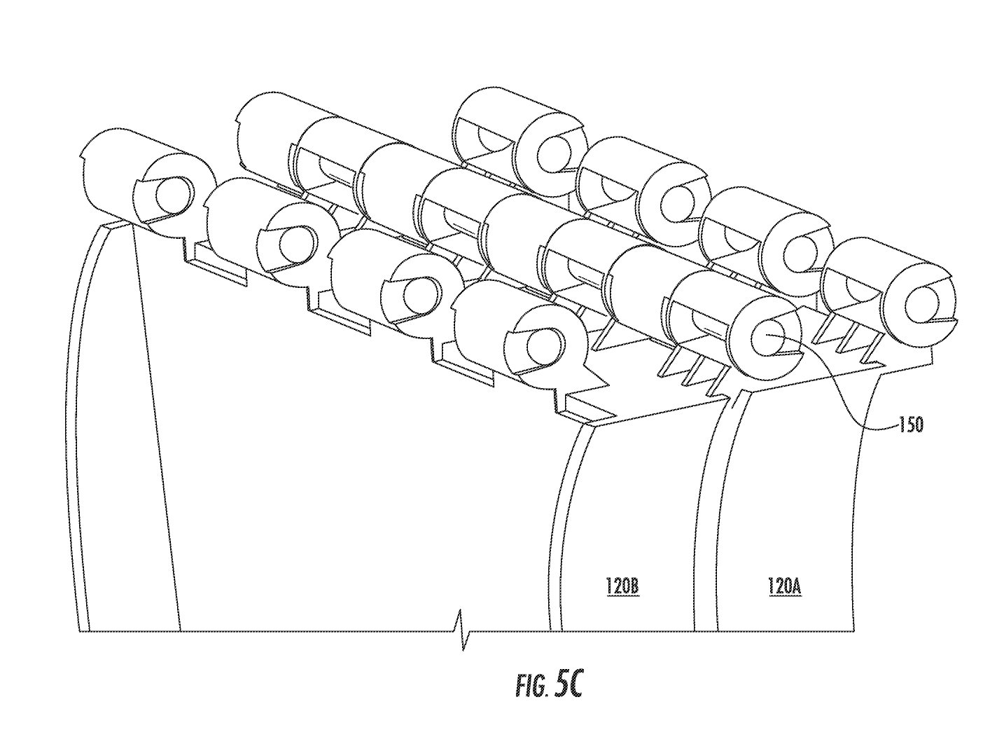

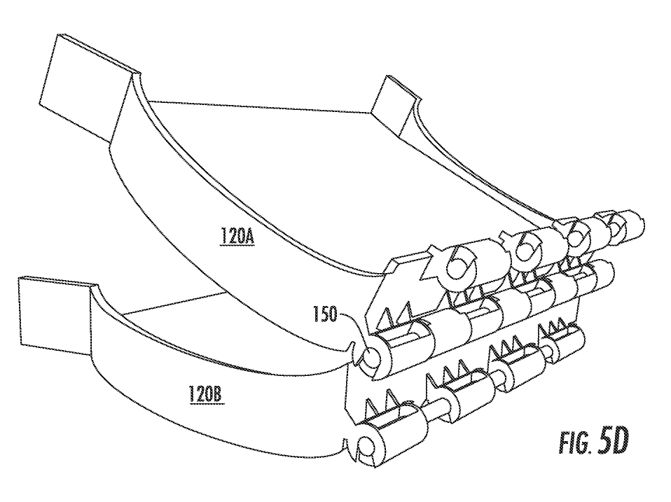

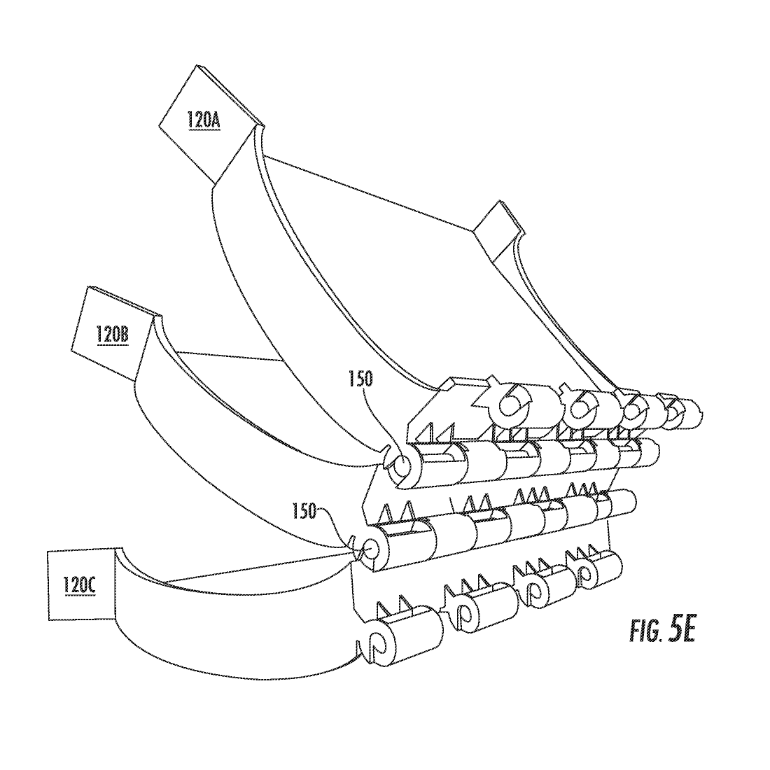

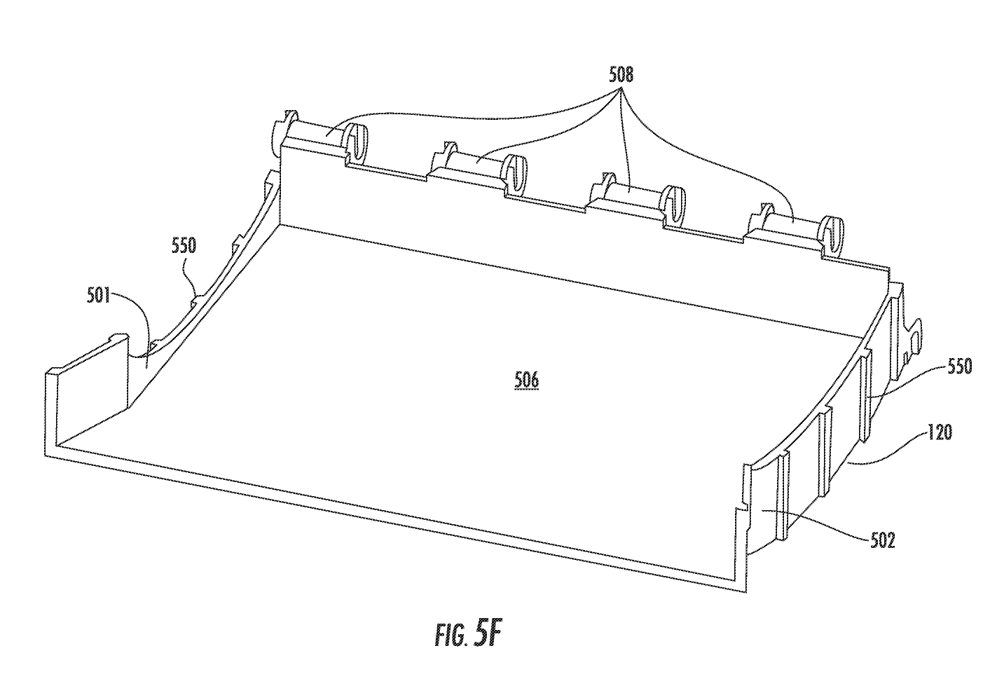

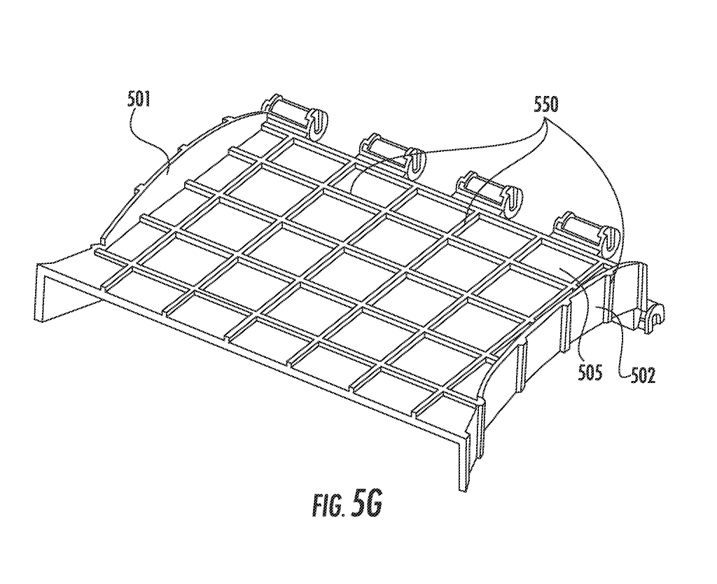

Referring now to FIG. 1, a pick and stow system 100 according to at least one embodiment of the invention is illustrated. The pick and stow system 100 includes a conveyor system 110, and in some embodiments, such as the embodiment shown, includes multiple conveyor systems 210, 310, and 410 mounted on a frame 115. Each conveyor system includes a plurality of adjacent modules 120A, 120B, 120C, etc. that are interconnected with each other via rods 150, thereby forming a continuous conveyor 110. Each module 120, embodiments of which are shown in greater detail in FIGS. 5A-5E, has a first side and a second side, either of which can form a shelf for stowing an item, such as, for example, a book.

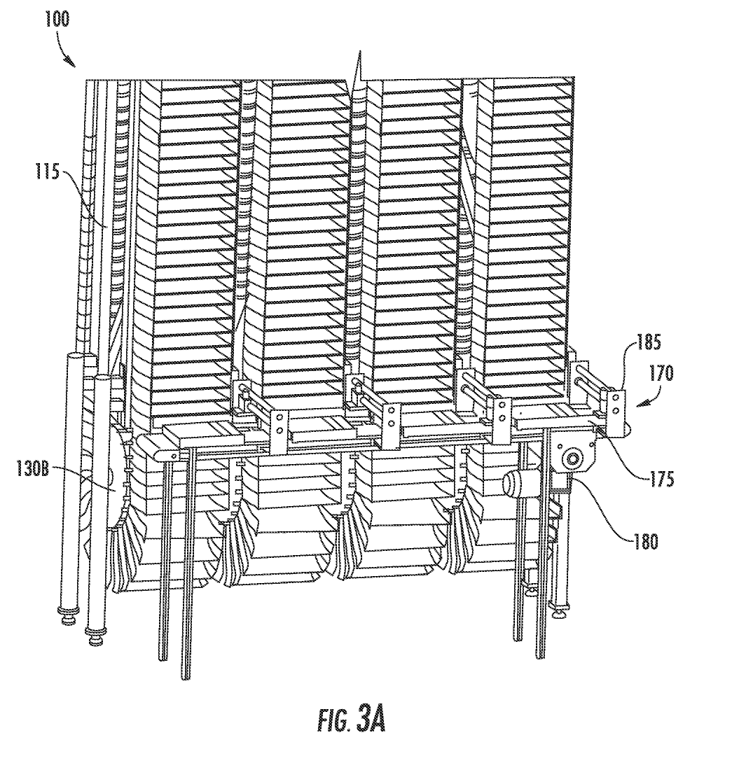

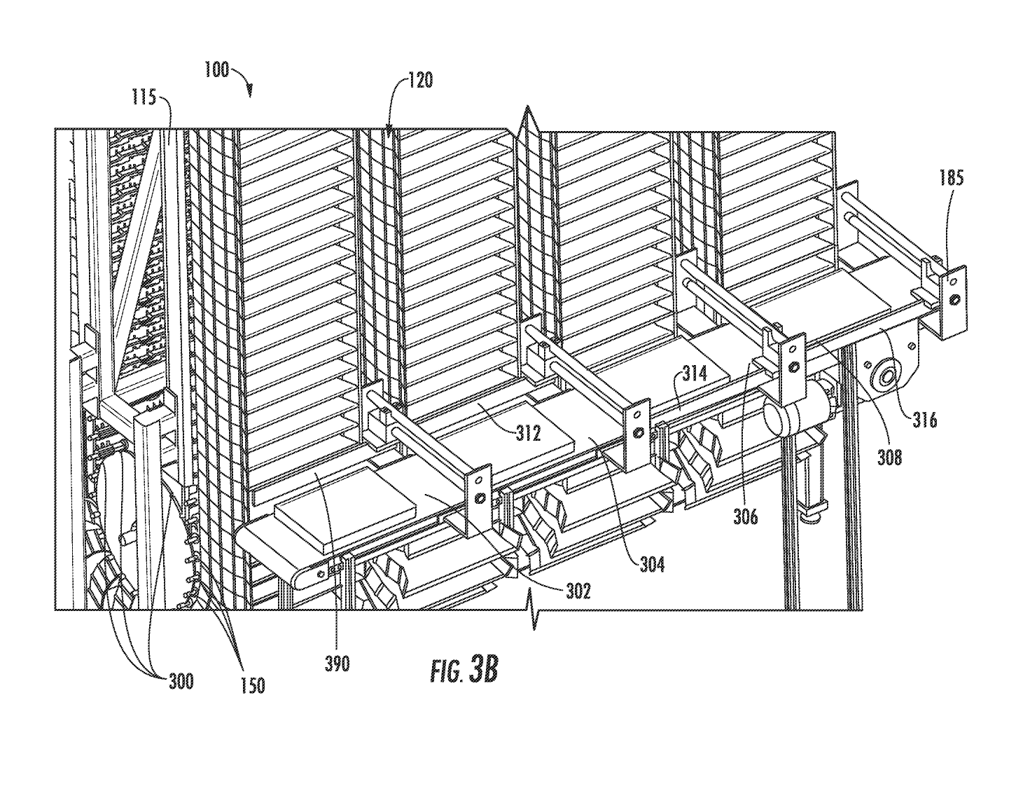

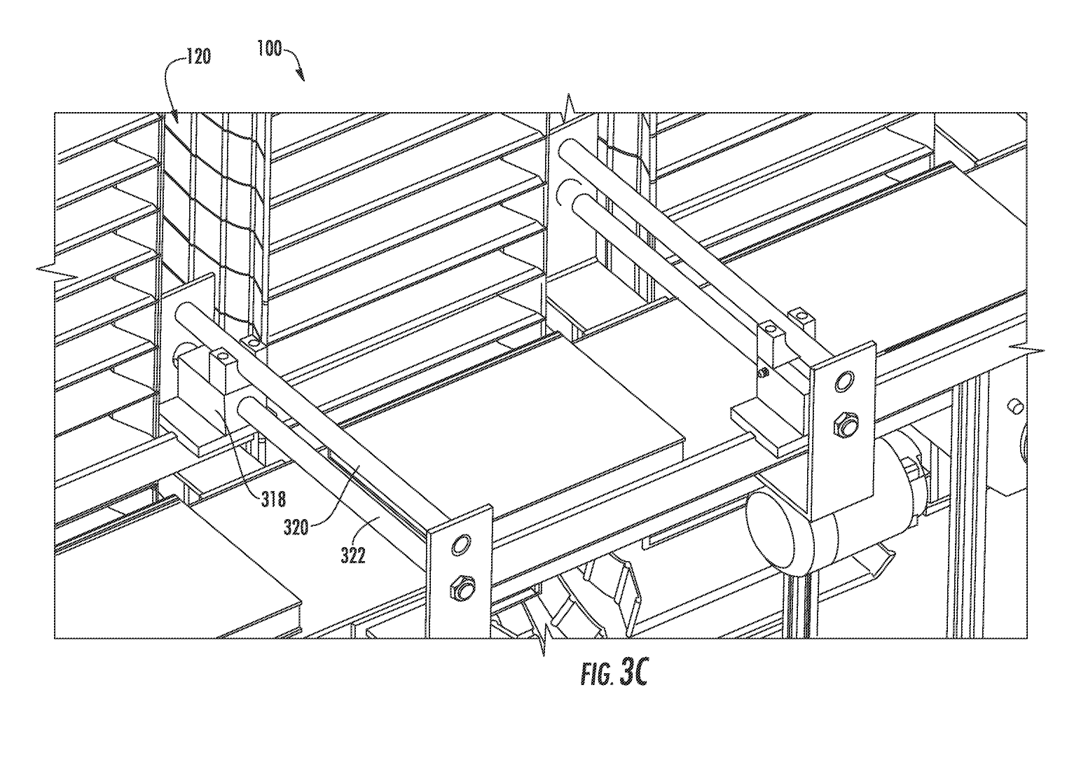

The conveyor system 110, in some embodiments, also includes a first set of wheels 130A and a second set of wheels 130B, collectively referred to as wheels 130, about which the conveyor systems 110 are driven. In some embodiments, the first wheels 130A and the second wheels 130B are sprockets that include a plurality of spaced apart teeth 300, as shown in FIG. 3B. The teeth 300 of the wheels 130 are configured to couple with a plurality of the rods 150 (also shown in FIGS. 5A-5E), interconnecting the adjacent plurality of modules 120A, 120B, 120C, etc. to thereby engage and drive the modules. One or more conveyor drivers 160 are connected to one or both of the wheels 130 to thereby operate the conveyor system 110.

Referring now to FIG. 5A, a module 120 is shown from its top according to embodiments of the invention. The module 120, in the embodiment shown, has two walls 501 and 502 for retaining an item in a shelf 504 defined by the module's 120 upper side 506 (i.e., first side) and the two walls 501 and 502. Opposite the upper side 506 is an under side 505 (i.e., second side) of the module which is not visible in FIG. 5A. The module 120 includes a plurality of upper rod receivers 508 configured for receiving a rod 150. The upper rod receivers 508, in the embodiment shown, are spaced such that lower rod receivers, similar to lower rod receivers 510, from another module 120 also receive the rod 150, thereby creating a hinged interconnection between the modules 120 such that they can rotate about the rod 150.

Referring now to FIGS. 5B, 5C, and 5D concurrently, several views of two interconnected modules 120A and 120B are shown. In these embodiments, module 120A has lower rod receivers 510A that are configured such that module 120B's upper rod receivers 508B are offset from them, thereby forming a hinge when the respective rod receivers are interleaved and coupled with the rod 150. Similarly, in FIG. 5E, three modules 120A, 120B and 120C are shown, each having upper rod receivers and lower rod receivers such that each module is configured for forming a hinge with another module and a rod. Referring now to FIG. 5F, in some embodiments, the upper side 506 of the module remains smooth, thus allowing ease of ingress and egress of desired items. However, as shown in FIG. 5G, in some embodiments, the modules 120 are structurally enhanced by the addition of a plurality of ribbings 550 configured for providing strength and rigidity to the modules 120. The ribbings may be located on the outer side surfaces of the two walls 501 and 502 of the modules 120 and the bottom surface 505 of the modules 120. In addition to providing reinforcement, in some embodiments, the ribbing located on the bottom surface 505 of the modules may reduce surface contact and/or retention between an item and the bottom surface when the two are in contact.

In the illustrated embodiment of the Figures, the conveyor system 110 is oriented in a generally vertical manner relative to a support surface. In operation, the modules 120 of the conveyor system are moved vertically as needed to align individual modules 120 with a supply conveyor to thereby either insert or remove items from the modules. An individual module changes orientation as the conveyor is operated. For example, the module may initially be located at a front side of the conveyor in an upright orientation. As the conveyor system is operated vertically, however, the module may move from a front side of the conveyor system, over the top of the conveyor system, and to the back side of the conveyor system. To avoid item retention issues in the modules over this range of movement, adjacent modules allow for items retained by the top surface of one module to transfer via gravity and be retained by a bottom surface of an adjacent module. As an example, an item located on the upper side 506 of module 120B when module 120B is on the front side of the conveyor system 110 will be transferred to the bottom surface 505 of the adjacent module 120A when the module 120B is moved over the top of the conveyor system 110 to the back side of the conveyor system 110.

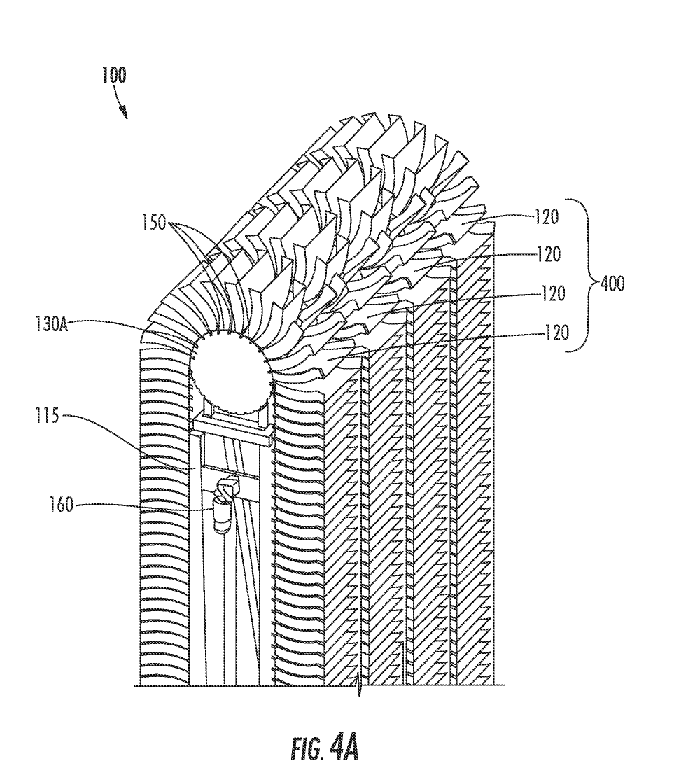

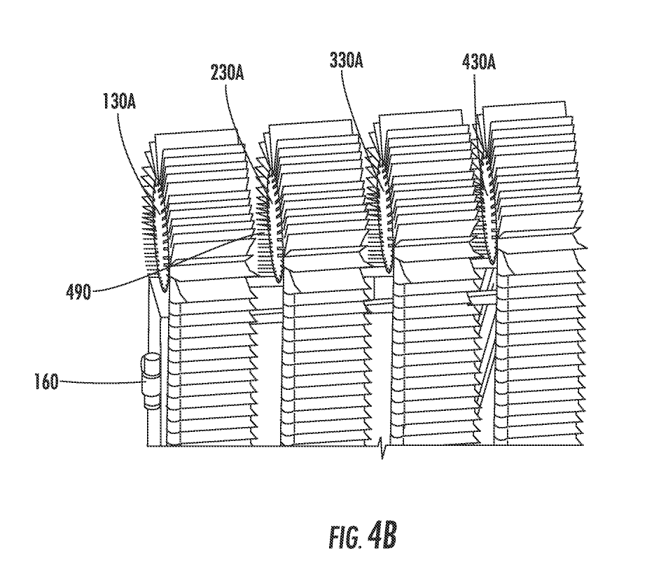

The system 100, in various embodiments, includes only one conveyor system 110 and in other embodiments, such as the one shown in the illustrated Figures, includes several conveyor systems 110, 210, 310, 410, etc. In various embodiments where the system 100 includes multiple conveyor systems (e.g., 110, 210, 310, or 410), the conveyor systems are driven simultaneously, and in other embodiments, at least some or all operate independently of one another, that is, they are driven separately by different conveyor drivers. For example, in some embodiments wherein the system 100 includes multiple conveyor systems, two or more of the conveyor systems are driven simultaneously and one or more of the other conveyor systems are driven separately. For example, in one embodiment, wherein the system 100 has four conveyor systems 110, 210, 310, and 410, conveyor systems 110 and 210 may be interconnected and driven simultaneously by a common motor and conveyor systems 310 and 410 may be interconnected and driven simultaneously by a common motor and separately from conveyor systems 110 and 210. In another example, conveyor system 110 is driven separately from simultaneously driven conveyor systems 210, 310, and 410. As shown in FIG. 4A, simultaneously driven conveyor systems 110, 210, 310, and 410 in some embodiments, are facilitated by module sets 400 featuring multiple adjacent modules 120 of the different conveyor systems 110, 210, 310, and 410 that are coupled together across the different conveyor systems 110, 210, 310, and 410 via a single rod 150. This is not to be confused with two modules 120A and 120B being coupled via a single rod 150 in a single conveyor system 110 such as the configuration shown in FIG. 5E, but rather these module sets 400 include multiple adjacent modules 120 generally at the same height with respect to the system 100 and coupled together by a single rod 150 having sufficient length for the multiple modules 120. For example, a module 120 of conveyor system 110 may be connected to a module 120 of an adjacent conveyor system 210 by a common rod 150. In some such embodiments, module set 400, coupled by a single rod 150 can be driven simultaneously by a single conveyor driver 160 coupled with a single wheel 130 with teeth 300. The conveyor driver 160, for example a motor such as a stepping motor or other type of motor, is controlled by a computer system external to the pick and stow system 100 in some embodiments.

In some embodiments, the pick and stow system 100 includes a processing device configured for providing instructions for driving the conveyor system(s) 110. In embodiments where the conveyor driver 160 is a stepping motor, the processing device or external computer system is configured to provide stepping instructions for the motor such that the motor drives the wheel 130 and the conveyor system 110 to the desired configuration such that one or more items picked and/or stowed at a loading location. In other words, the conveyor driver 160, in various embodiments, drives the conveyor system(s) 110 such that the desired module(s) 120 or module set 400 of FIG. 4A is presented at the loading location for loading or removing one or more items from the module(s) or module set 400.

The pick and stow system 100 in some embodiments includes a supply conveyor system 170 as shown in FIG. 3A. In some embodiments, such as the embodiment shown, the supply conveyor system includes a horizontal conveyor 175 configured for transporting one or more objects to a loading location proximate one or more conveyor systems 110 such that the item(s) can be loaded or removed from the desired modules 120 of the conveyor systems 110. The supply conveyor system 170, in some embodiments, is driven by a supply driver 180, which is a motor such as a stepping motor in some embodiments. In some embodiments, both the supply driver 180 and the conveyor driver 160 are controlled by the same computer system and/or processing device. In some embodiments, the processing device is part of the pick and stow system 100, and in other embodiments, a computer system or processing device external to the pick and stow system 100 controls one or both the conveyor driver 160 and/or the supply driver 180.

The supply conveyor system 170, in some embodiments, includes a loading system 185 configured for loading an item onto the shelf of a module 120. In some embodiments, the loading system 185 includes an air cylinder and pusher fingers or other item pushing apparatus. In other embodiments, different force generating devices are used, such as magnetic force device or the like. The loading system 185 is configured for receiving control signals, such as from a processing device internal or external to the pick and stow system 100 for loading the item(s) onto the desired module(s) 120.

In some embodiments, the pick and stow system 100 includes a removal system 190 (not shown) typically disposed within the frame 115 of the system 100. The removal system 190 is configured for removing one or more items from one or more modules 120. The removal system 190, in some embodiments, includes components similar to the loading system 185 such as an air cylinder or other force generating apparatus and pusher fingers or other pushing apparatus and is configured for receiving control signals from a processing device, either internal or external to the pick and stow system 100, for pushing the item(s) out of the modules 120.

In various other embodiments, other systems for loading and/or removing items from modules 120 are used. For example, in some embodiments, one or both the loading system 185 and the removal system 190 include a pulling apparatus such as a vacuum configured for pulling the item onto or away from the module 120. Of course, in such a configuration, the location of the pulling apparatus is modified to accommodate the necessary direction of force application. For example, in one embodiment wherein the loading and the removal systems 185 and 190 include pulling apparatuses, the loading system is generally disposed within the frame 115 of the system 100 such that the applied pulling force pulls the item from the conveyor 175 of the supply conveyor system 170 into the desired module 120, and the removal system is generally disposed outside the frame 115 of the system 100 such that the applied pulling force pulls the item from the module 120 onto the conveyor 175 of the supply conveyor system 170.

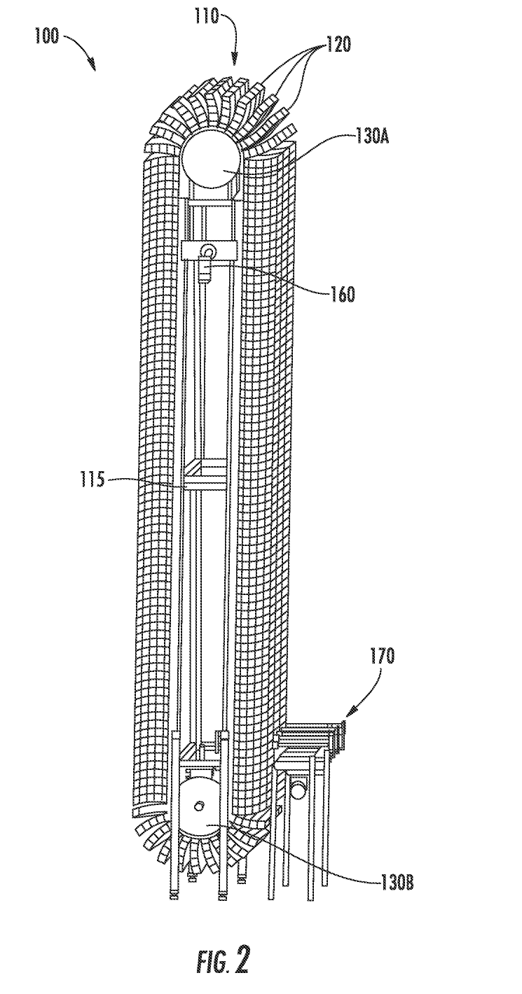

Referring now to FIG. 2, a side view of the pick and stow system 100 according to embodiments of the invention is illustrated. The system 100 includes, as discussed above, a conveyor system 110 including a plurality of modules 120 forming a continuous conveyor driven about wheels 130A and 130B by the conveyor driver 160. The conveyor system 110 is mounted on frame 115 and interacts with the supply conveyor system 170.

Referring now to FIGS. 3A, 3B, and 3C, views of the supply conveyor system 170 from varying depths in view are illustrated according to embodiments of the present invention. It should be noted in the various Figures, Applicant has shown the supply conveyor system 170 as terminating proximate the sides of the Figure. However, in various embodiments of the invention, the supply conveyor system includes a conveyor that extends beyond the bounds of the illustrations shown. That is, for example, the conveyor 175 of the supply conveyor system 170 originates remotely from the pick and stow system 100 and/or terminates remotely from the pick and stow system 100. In this regard, the supply conveyor system 170 can be supplied with one or more item(s) for stowing by a remote source and/or can transport one or more items removed from the pick and stow system 100 to a remote destination. In one example, the supply conveyor system 170 is removing items from the pick and stow system 100 and transports such items to another remote system for packaging and shipping based on instructions from an exterior processing device. In one such embodiment, for example, the processing device is carrying out an order for one or more products being stowed by the pick and stow system 100, and therefore provides coordinated instructions to the supply conveyor system 170, the removal system 190 and the pick and stow system 100 in order to effect removal of the ordered products from the pick and stow system and transportation of the ordered items to a packaging/shipping system (not shown).

As shown in FIG. 3B, the supply conveyor system 170 of the illustrated embodiment includes loading systems 185 utilizing a pushing force. For example, in the two left-hand loading locations 302 and 304, the loading systems 185 are positioned in a stowing position, whereas in the two right-hand loading locations 306 and 308, the loading systems 185 are positioned in a ready position. In the loading position, the pushing device, such as pushing device 390 or pushing device 312 has been driven such that it will have pushed the item, if an item is present on the conveyor, into the desired module 120. In the ready position, the pushing device, such as pushing device 314 or pushing device 316 has not yet been driven to push the item into the desired module 120, but rather, the pushing device stands ready to be driven from the ready position to the stowing position. Referring now to FIGS. 3B and 3C concurrently, in some embodiments, the driving force is applied by an air pressure system, and in other embodiments, other types of systems are used to apply the driving force. In the embodiment shown, the pushing device 312 is an arm attached to a slider 318 configured for sliding along one or more rods 320 and 322. In some embodiments, the slider 318 is driven by an air pressure system implemented via rod 322. In other embodiments, the slider 318 is driven by electromotive force, electromagnetic force or some other force.

Referring now to FIG. 4A, in some embodiments as mentioned above, the conveyor systems 110 are driven simultaneously, that is, conveyor system 110 and conveyor system 210 is driven by a conveyor driver 160 simultaneously such that the modules 120 of the first conveyor system 110 are driven alongside the modules of the second conveyor system 210 such that a particular module 120 of conveyor system 110 is driven side-by-side with a particular module 120 of conveyor systems 210, 310, and 410 to form a module set 400. As shown in FIG. 4B, in some embodiments, the conveyor systems 110, 210, 210, and 410 are driven by a single conveyor driver 160 coupled with a wheel, such as wheel 130A and an attached axel 490. The axel 490, in the embodiment shown, extends through each of wheels 230A, 330A, and 430A. In some embodiments, the axel 490 is attached to the various wheels such that the axel 490 rotates along with the wheels as they are driven. Hence, in embodiments where the conveyor driver 160 drives either the wheel 130A, the axel 490 or some other wheel or axel communicating with wheel 130A and/or axel 490, all the wheels are also driven such that their respective conveyor systems are driven as well.

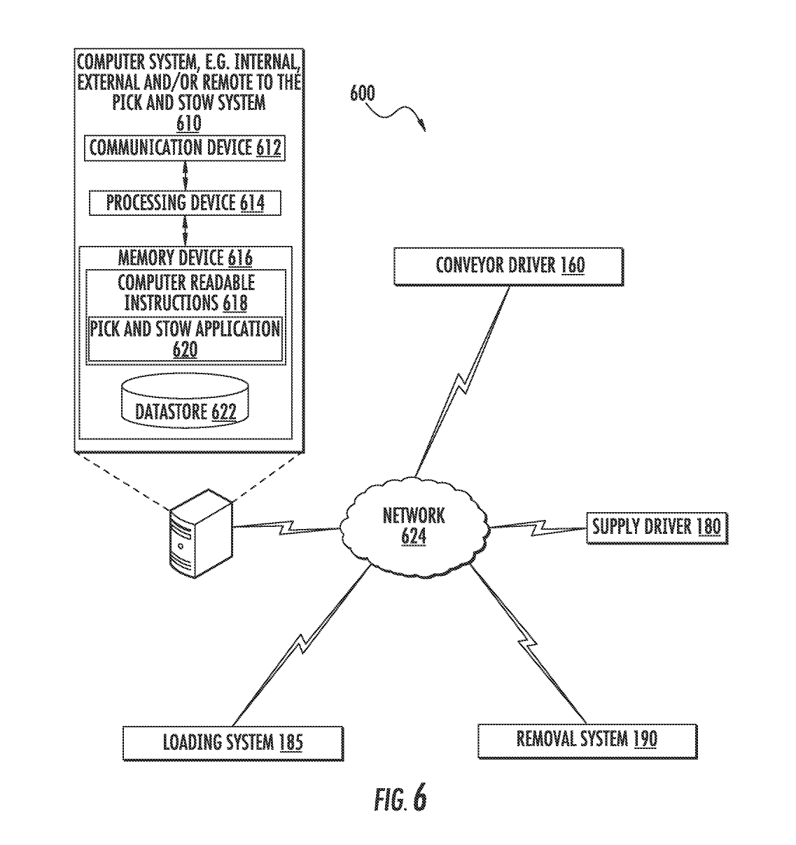

Referring now to FIG. 6, an environment 600 wherein the pick and stow system operates is illustrated. A computer system 610, such as, for example, a personal computer, server or other computing device, either internal to the pick and stow system or external to the pick and stow system, includes a processing device 614 in communication with a memory device 616 and a communication device 612. The processing device is configured for controlling the communication device 612 to communicate over the network 624 with one or more other systems. The network 624 is any direct connection, local area network, wide area network, the Internet or any combination of the same. In various embodiments, the computer system 610 communicates with the conveyor driver 160, the supply driver 180, the removal system 190, and/or the loading system 185, such as loading system 185 discussed above. In some embodiments, the memory device 616 of the computing device 610 is configured for storing computer-readable instructions 618 such as applications for execution by the processing device 614 or some other processing device. In some embodiments, the computer-readable instructions include program code related to the pick and stow system, such as a pick and stow application 620. The computing device, in some embodiments, also includes a datastore 622 configured for storing, for example, data regarding the stowed locations of specific items. For example, in one embodiment, the datastore houses information indicating the module where a particular book is stored. Thus, when a request is received for removal of that particular book, the computing device accesses the database in order to determine the stowed location, retrieves the book, and removes it from the system.

In some embodiments, the pick and stow application includes instructions for controlling one or more of the conveyor driver 160, the supply driver 180, the removal system 190, and/or the loading system 185. In some embodiments, the computing device 610 coordinates automated operation of the entire pick and stow system such that each of the sub-systems discussed above interact efficiently. In other embodiments, one or more other computing or processing devices are used to control one or more of the sub-systems of the pick and stow system. For example, in one embodiment, the loading system includes a dedicated processing device connected with sensors indicating when an item is ready for loading and when the conveyor system has stopped moving. In this regard, the loading system may need no additional control or instruction for carrying out its loading process. In other embodiments, however, integrated control of the various sub-systems assists multi-stepped operations and efficiency.

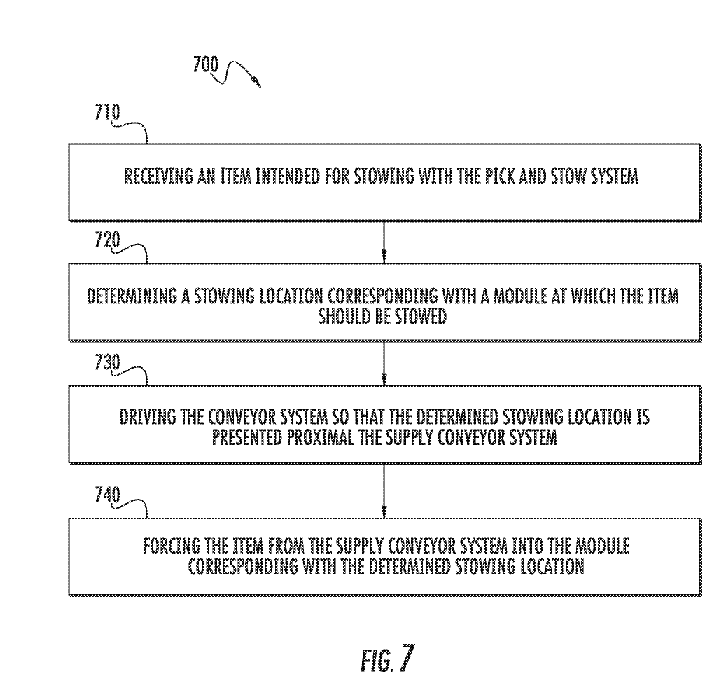

Referring now to FIG. 7, a flowchart illustrates a method 700 for loading an item in the pick and stow system according to embodiments of the invention. The first step is receiving an item intended for stowing with the pick and stow system, as represented by block 710. In some embodiments, the supply conveyor system brings an item from a source, such as a person or some other stowing system, and the pick and stow system receives the item via the supply conveyor. The next step, as represented by block 720, is determining a stowing location corresponding with a module at which the item should be stowed. In some embodiments, the supply conveyor system includes an item scanner or reader capable of scanning or reading an indicator disposed on or in the item. For example, in one embodiment, the supply conveyor system includes a bar-code reader and the item is a book having a bar-code indicia disposed thereon. The bar-code reader scans the bar-code and determines, based on the information received from the bar code, the appropriate stowing location. In some embodiments, the determination of stowing location is further based on the availability of stowing locations. Hence, the information gathered from the item itself is, in some cases, supplemented by information from the pick and stow system itself, such as capacity and available stowing locations. In one embodiment, for example, only one stowing location was available within a pre-determined range of stowing locations for a book on a particular subject corresponding to the pre-determined range of stowing locations. In this example, the system stows the book in the only available location. As another example, if no stowing locations within the pre-determined range were available, the system may be programmed to determine the next closest stowing location. In yet other embodiments, the items are not stowed based on similarities, but rather are stowed based on efficiency considerations. For example, in one embodiment, an item is deemed to be stowed and removed on a frequent basis, and therefore is assigned a stowing location alongside many other frequently stowed and removed items. Thus, the system can more efficiently stow and remove frequently requested items than had they been scattered in stowing locations throughout the system.

The next step, as represented by block 730, is driving the conveyor system so that the determined stowing location is presented proximal the supply conveyor system. Once the stowing location is determined, the conveyor driver drivers the conveyor such that the module corresponding with the proper stowing location is presented proximate the supply conveyor system. The final step, as represented by block 740, is forcing the item from the supply conveyor system into the module corresponding with the determined stowing location. The removal system uses either a pushing or pulling force to load the item onto the module. For example, concentrated compressed air is used to push the item from the module onto the supply conveyor system in some embodiments.

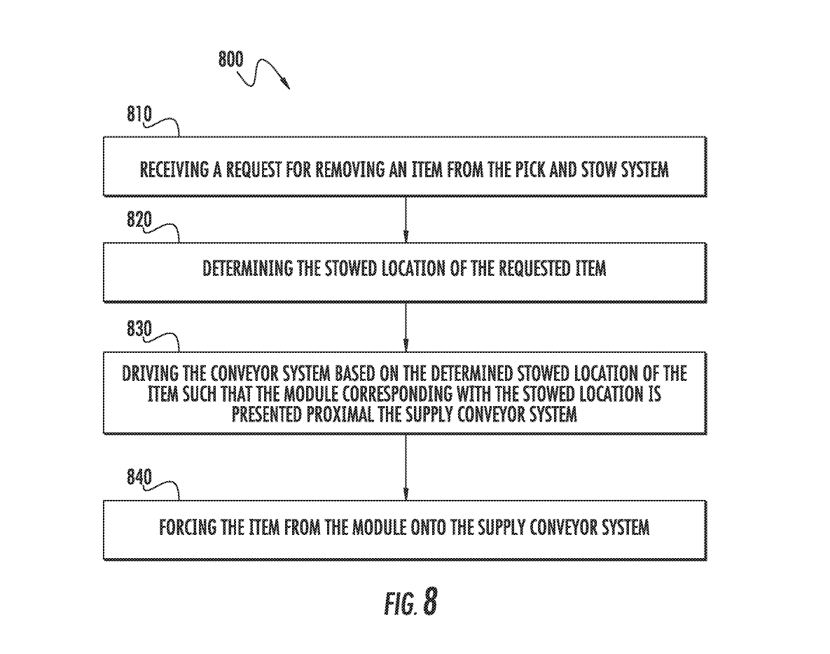

Referring now to FIG. 8, a flowchart illustrates a method 800 for removing an item from the pick and stow system according to embodiments of the invention. The first step is receiving a request for removing an item from the pick and stow system, as represented by block 810. In some embodiments, the request is received at a user terminal and communicated to the computing system, where the processing device receives the request. The next step, as represented by block 820, is determining the stowed location of the requested item. In some embodiments, based on the information received in the request, the computing system can access the datastore to retrieve information corresponding to the information in the request. Once the requested item or items have been identified, that is, their specific stowed locations have been determined, the next step, as represented by block 830, is driving the conveyor system based on the determined stowed location of the item. The computer device or other controller instructs the conveyor driver to present the module corresponding with the stowed location proximal the supply conveyor system. The final step, as represented by block 840, is forcing the item from the shelving module onto the supply conveyor system. Similar to step 740 discussed above, the removal system applies either a pushing or pulling force, in various embodiments, to remove the item from the module.

In summary, according to embodiments of the invention, a pick and stow system includes a conveyor system having a plurality of interconnected modules forming a continuous conveyor, each module having a first side and a second side and each configured for forming a shelf on both the first side and the second side. The system also includes a conveyor driver coupled with the conveyor and configured for driving the conveyor, thereby presenting one of the plurality of modules at a loading location for loading or removing an item onto or from the shelf of the module. In some embodiments, a first wheel and a second wheel are each configured for coupling with each of the plurality of modules of the conveyor as the conveyor is driven about the first wheel and the second wheel, such that the conveyor has two substantially vertical sections and a curved section at each of the first and second wheels. In some embodiments, multiple conveyors are driven simultaneously and interact with the supply conveyor system simultaneously.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device or other device may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A pick and stow system comprising:
a conveyor system comprising:
a plurality of interconnected modules forming a continuous conveyor, each module having a first side and a second side and each configured for forming a shelf on both the first side and the second side depending on the orientation of the module; and
a conveyor driver coupled with the conveyor and configured for driving the conveyor, thereby presenting one of the plurality of modules at a loading location for loading or removing an item onto or from the shelf of the module.

2. The pick and stow system of claim 1, further comprising:
a supply conveyor system configured for interacting with the conveyor proximate the loading location and for loading or removing an item onto or from the shelf of the module.

3. The pick and stow system of claim 1, wherein the conveyor driver comprises a motor coupled with the conveyor and configured for driving the conveyor.

4. The pick and stow system of claim 3, wherein the motor comprises a stepping motor configured for receiving stepping instructions for driving the conveyor such that each of the plurality of modules can be presented at the loading location based on particular stepping instructions.

5. The pick and stow system of claim 1, wherein the conveyor system further comprises:
a second plurality of interconnected modules forming a second continuous conveyor, each module having a first side and a second side and each configured for forming a shelf on both the first side and the second side.

6. The pick and stow system of claim 5, wherein the continuous conveyor and the second continuous conveyor are coupled such that the conveyor driver drives them simultaneously.

7. A pick and stow system comprising:
a conveyor system comprising:
a plurality of interconnected modules forming a continuous conveyor, each module having a first side and a second side and each configured for forming a shelf on both the first side and the second side;
a first wheel at an upper location and configured for coupling with each of the plurality of modules of the conveyor as the conveyor is driven about the first wheel;
a second wheel at a lower location and configured for coupling with each of the plurality of modules of the conveyor as the conveyor is driven about the second wheel, such that the conveyor has two substantially vertical sections and a curved section at each of the first and second wheels, the modules comprising the two substantially vertical sections and the curved section subject to change as the conveyor is driven; and
a conveyor driver configured for coupling with and driving at least one of the first or second wheels, thereby driving the conveyor and presenting one of the plurality of modules at a loading location for loading or removing an item onto or from the shelf of the module.

8. The pick and stow system of claim 7, further comprising:
a supply conveyor system configured for interacting with the conveyor proximate the loading location and for loading or removing an item onto or from the shelf of the module.

9. The pick and stow system of claim 7, wherein the conveyor driver comprises a motor coupled with the conveyor and configured for driving the conveyor.

10. The pick and stow system of claim 9, wherein the motor comprises a stepping motor configured for receiving stepping instructions for driving the conveyor such that each of the plurality of modules can be presented at the loading location based on particular stepping instructions.

11. The pick and stow system of claim 7, wherein the conveyor system further comprises:
a second plurality of interconnected modules forming a second continuous conveyor, each module having a first side and a second side and each configured for forming a shelf on both the first side and the second side.

12. The pick and stow system of claim 11, wherein the continuous conveyor and the second continuous conveyor are coupled such that the conveyor driver drives them simultaneously.

13. A pick and stow system comprising:
a conveyor system comprising:
a plurality of interconnected modules forming a continuous conveyor, each module having a first side and a second side and each configured for forming a shelf on both the first side and the second side;
a first wheel at an upper location and configured for coupling with each of the plurality of modules of the conveyor as the conveyor is driven about the first wheel;
a second wheel at a lower location and configured for coupling with each of the plurality of modules of the conveyor as the conveyor is driven about the second wheel, such that the conveyor has two substantially vertical sections and a curved section at each of the first and second wheels, the modules comprising the two substantially vertical sections and the curved section subject to change as the conveyor is driven; and
a conveyor driver configured for coupling with and driving at least one of the first or second wheels, thereby driving the conveyor and presenting one of the plurality of modules at a loading location for loading or removing an item onto or from the shelf of the module; and
a supply conveyor system configured for interacting with the conveyor proximate the loading location and for loading or removing an item onto or from the shelf of the module.

14. The pick and stow system of claim 13, wherein the supply conveyor system comprises a loading system configured for loading the item onto the shelf of the module.

15. The pick and stow system of claim 13, wherein the conveyor driver comprises a motor coupled with the conveyor and configured for driving the conveyor.

16. The pick and stow system of claim 15, wherein the motor comprises a stepping motor configured for receiving stepping instructions for driving the conveyor such that each of the plurality of modules can be presented at the loading location based on particular stepping instructions.

17. The pick and stow system of claim 13, wherein the conveyor system further comprises:
a second plurality of interconnected modules forming a second continuous conveyor, each module having a first side and a second side and each configured for forming a shelf on both the first side and the second side.

18. The pick and stow system of claim 17, wherein the continuous conveyor and the second continuous conveyor are coupled such that the conveyor driver drives them simultaneously.

19. The pick and stow system of claim 18, wherein the supply conveyor system is configured for interacting with the conveyor and the second conveyor proximate the loading location and for loading or removing items onto or from the shelf of a module of both the conveyor and the second conveyor.

20. The pick and stow system of claim 13, wherein two of the plurality of modules are interconnected by both coupling with a rod, the rod being configured for coupling with at least one of the first wheel or the second wheel such that the first or second wheel, when driven, also drives the rod and thereby the modules.

21. A method for stowing an item at a pick and stow system comprising a conveyor system and a supply conveyor system, the method comprising:
providing a conveyor system comprising:
a plurality of interconnected modules forming a continuous conveyor, each module having a first side and a second side and each configured for forming a shelf on both the first side and the second side depending on the orientation of the module; and
a conveyor driver coupled with the conveyor and configured for driving the conveyor, thereby presenting one of the plurality of modules at a loading location for loading or removing an item onto or from the shelf of the module;
receiving an item intended for stowing in the conveyor system;
determining, by a processing device, a stowing location corresponding with a module at which the item should be stowed;
driving the conveyor system such that the determined stowing location is presented proximal the supply conveyor system; and
forcing the item from the supply conveyor system into the module corresponding with the determined stowing location.

22. The method of claim 21, wherein forcing the item from the supply conveyor system into the module corresponding with the determined stowing location comprises pushing the item from the supply conveyor system into the module.

23. The method of claim 21, wherein forcing the item from the supply conveyor system into the module corresponding with the determined stowing location comprises pulling the item from the supply conveyor system into the module.

24. A method for removing an item from a pick and stow system comprising a conveyor system and a supply conveyor system, the method comprising:
providing a conveyor system comprising:
a plurality of interconnected modules forming a continuous conveyor, each module having a first side and a second side and each configured for forming a shelf on both the first side and the second side depending on the orientation of the module; and
a conveyor driver coupled with the conveyor and configured for driving the conveyor, thereby presenting one of the plurality of modules at a loading location for loading or removing an item onto or from the shelf of the module;
receiving a request for removing an item from the conveyor system;
determining the stowed location of the requested item;
driving the conveyor system based on the determined stowed location of the item such that the module corresponding with the stowed location is presented proximal the supply conveyor system; and
forcing the item from the module onto the supply conveyor system.

25. The method of claim 24, wherein forcing the item from the module onto the supply conveyor system comprises pushing the item from the module onto the supply conveyor system.

26. The method of claim 24, wherein forcing the item from the module onto the supply conveyor system comprises pulling the item from the module onto the supply conveyor system.
